(19) United States
(12) Patent Application Publication
(10) Pub. No.: US 2002/0171634 A1
(43) Pub. Date: Nov. 21, 2002

(54) DATA INPUT DEVICE USING A LAMINATED SUBSTRATE CAPABLE OF RELIABLY FILLING THROUGH HOLES WITH ELECTROCONDUCTIVE MATERIAL

(76) Inventor: HIDETO MATSUFUSA, FUKUSHIMA-KEN (JP)

Correspondence Address: BRINKS HOFER GILSON & LIONE, P.O. BOX 10395, CHICAGO, IL, 60611, US

(21) Appl. No.: 09/457,585

(22) Filed: Dec. 9, 1999

(30) Foreign Application Priority Data
Dec. 18, 1998 (JP) 10-361657

(51) Int. Cl. G09G 5/00

(52) U.S. Cl. 345/173

(57) ABSTRACT

A laminated substrate includes a first substrate having electrodes and through-holes formed thereon, a second substrate having wiring patterns formed thereon and laminated under the first substrate through an insulating layer, an electroconductive material filled in the through-holes so that the electrodes of the first substrate are electrically conducted to the wiring patterns of the second substrate therethrough, and air vent passages having longitudinal paths passing through the first substrate and communicating with the outside from the front surface of the first substrate and lateral paths located between the first substrate and the second substrate for communicating the longitudinal paths with the through-holes. With this arrangement, when both the substrates are electrically conducted to each other, the electrodes of the first substrate are electrically conducted to the wiring patterns of the second substrate reliably through the conductive material which is filled in the through-holes securely.

### BACKGROUND OF THE INVENTION

1. Field of the Invention

The present invention relates to a laminated substrate in which electrodes formed on one of substrates, which are used for various types of electronic products, are electrically connected to the electrode wiring patterns formed on the other substrate through through-holes formed on the substrates and to a pad type data input device employing the laminated substrate for use in a computer and the like.

2. Description of the Related Art

Recently, a large number of computers called a note type computer are used in offices, households and the like for the purpose of saving space. Many pad type input devices, which can be operated by being lightly traced with a finger, are used in these note type computers as an input device for moving a cursor and the like displayed on a screen.

FIG. 5 is a sectional view showing the structure of the main portion of a conventional data input device.

The data input device 40 is a pad type data input device used in computers and the like and composed of a sensor sheet 10 for detecting a coordinate, a printed circuit board (hereinafter, abbreviated as PCB) 21 on which wiring patterns are printed, a bonding layer 8 for bonding the sensor sheet 10 to the PCB 21 and a face sheet 30 as a portion which an operator touches with his or her finger or the like.

The sensor sheet 10 includes a sensor substrate 2 for detecting a coordinate, which a finger is in touch with, and resist films 6 and 7 formed on both the surfaces of the sensor substrate 2, respectively. The sensor substrate 2 is arranged such that x-electrodes 12 and y-electrodes 13 are formed on both the surfaces of a sheet composed of polyethylene terephthalate (PET) or the like. The sensor sheet 10 is bonded to the PCB 21 by the bonding layer 8.

A Plurality of through-holes 70 are formed along the peripheral edges thereof. Further, lands 92 are disposed to PCB 21 to join the y-electrodes 13 formed on the sensor substrate 2 to the wiring patterns of the PCB 21 through through-holes 70.

Further, through-holes 60 are also formed on the sensor sheet 10 so as to communicate with the through-holes 70 of the PCB 21. The y-electrodes 13 of the sensor substrate 2 are electrically connected to the lands 92 of the PCB 21 by filling the through-holes 60 and 70 with an electroconductive material 11 such as an electroconductive resin from the sensor substrate 2 side.

The face sheet 30 is secured on the upper surface of the above sensor sheet 10 by an adhesive or the like. Further, parts such as IC and the like necessary to data input processing are mounted on the side of the PCB 21 opposite to the sensor sheet 10, that is, on the parts-mounting-surface (lower surface in the figure) of the PCB 21.

In the data input device 40 arranged as described above, a portion of electric line of force, which is directed from the x-electrodes 12 to the y-electrodes 13, is absorbed by the operator's finger in the x-electrodes 12 and the y-electrodes 13 formed on the sensor substrate 2 in such a manner that the operator slides the face sheet 30 so as to lightly scrape it with the finger. The electric line of force absorbed by the y-electrodes 13 is reduced thereby and a phenomenon that capacitance is changed arises. Then, the coordinate of a position against which the finger is pressed can be detected based on the value of a current output from the sensor substrate 2 which is changed in accordance with the change of the capacitance.

In the data input device 40 shown in FIG. 5, the PCB 21 is a both-side substrate having the wiring patterns formed on both the sides thereof and the lands 28 and 92 on both the sides thereof are electrically connected passing through the through-holes 70. Thus, when the y-electrodes 13 of the sensor substrate 2 are electrically connected to the land 28 of the lands 28, the electroconductive material 11 need not reach the lands 28 on the part-mounting-surface side and the PCB 21 can be electrically connected to the sensor substrate 2 when the electroconductive material 11 is connected to the lands 92 of the PCB 21 on the sensor substrate 2 side thereof.

However, the conventional data input device 40 has problems in the following points.

In the above data input device 40, the y-electrodes 13 and the lands 92 both located in the interior of the laminated substrate are electrically connected to each other by the electroconductive material 11. Therefore, when the through-holes 60 are filled with the electroconductive material 11 from the sensor substrate 2 side, spaces 31, in which the air in the through-holes remains without being discharged to the outside, are liable to be formed as shown in FIG. 5. Thus, there is a possibility that the connection of the electroconductive material 11 to the y-electrodes 13 is prevented by the air, by which the spaces 31 are formed, and further by a solvent gas contained in the electroconductive material 11, and a problem is arisen thereby.

The PCB 21 has the wiring patterns formed on both the sides thereof and an electroconductive member such as a metal or the like must be formed on the inner wall surfaces of the through-holes 70 to join the patterns on both the sides to each other, from which a problem arises in that a manufacturing cost is increased.

This problem can be solved by using a PCB having wiring patterns formed on only one side thereof.

However, when, for example, a one-side-wired PCB having wiring patterns formed on only the parts-mounting-surface (lower surface in the figure) thereof in place of the PCB 21 having the wiring patterns printed on both the sides thereof, the electroconductive material 11 supplied from the sensor substrate 2 side must reach the lands 28 on the parts-mounting-surface side.

When it is intended to cause the electroconductive material 11 to reach the lands 28, there is a possibility that the electroconductive material 11 is prevented from reaching the lands 28 on the lower surface of the PCB 21 shown in the figure by the air, by which the spaces 31 are formed, or by the solvent gas contained in the electroconductive material 11.

Furthermore, there is also a problem that a disadvantage is liable to arise in that the electroconductive material 11 is disconnected in the through-holes and cannot be connected to the y-electrodes 13 and that the electroconductive material 11 does not reach the lands 28 of the PCB 21. This is caused by that the spaces 31 are thermally expanded after they are dried and cured and that the conductive material 11 is expanded in the through-holes.

There is a method of preventing the generation of solvent gas by means of a solvent-free electroconductive material in order to cause the electroconductive material 11, which is supplied to the through-holes 60 from the sensor substrate 2 side, to reach the lands 28 passing through the through-holes 70 and to connect the y-electrodes 13 to the lands 28 by the electroconductive material 11 so as to solve the above problems.

In this case, however, there arise a problem in that the solvent-free electroconductive material is very expensive. In addition, the method of using the solvent-free electroconductive material cannot remove the air by which the space 31 is formed.

In the data input device 40 arranged as described above, a frame ground is necessary to discharge the static electricity generated when a finger is in touch with the face sheet 30.

As shown in FIG. 5, when the both-sides-wiring PCB 21 is used, a frame ground 32, which is exposed to the edges of the PCB 21, can be formed using the wiring patterns of the PCB 21 on the sensor substrate 2 side thereof.

However, when the PCB having the wiring patterns formed on only the parts-mounting-side thereof is used, the frame ground cannot be formed on the surface of the PCB on the sensor substrate 2 side thereof. The frame ground formed on the parts-mounting-side of the PCB cannot sufficiently exhibit an effect for discharging the static electricity charged to the face sheet 30.

An object of the present invention, which was made in view of the above circumstances, is to provide a laminated substrate which can reliably fill through-holes with an electroconductive material when substrates are electrically connected to each other through the through-holes and in which the electrodes of a first substrate is electrically connected to the wiring patterns of a second substrate reliably by solving the above problems.

Another object of the present invention is to electrically connect both substrates reliably even in a laminated substrate in which one of the substrates has wiring patterns formed on only the side opposite to the side thereof confronting the other substrate.

Further, still another object of the present invention is to provide a data input device which uses a laminated substrate whose substrates are electrically connected to each other reliably and which can easily form a frame ground, is excellent in resistance to static electricity and has good appearance.

### SUMMARY OF THE INVENTION

To solve the above problems, a laminated substrate of present invention present invention is characterized by including a first substrate having electrodes and through-holes formed thereon; a second substrate having wiring patterns formed thereon and laminated under the first substrate through an insulating layer; an electroconductive material filled in through-holes so that the electrodes of the first substrate are electrically connected to the wiring patterns of the second substrate therethrough; and air vent passages having longitudinal paths passing through the first substrate and communicating with the outside from the front surface of the first substrate and lateral paths located between the first substrate and the second substrate for communicating the longitudinal paths with the through-holes.

In the laminated substrate arranged as described above, when the through-holes disposed to at least the first substrate are filled with the electroconductive material such as the electroconductive resin or the like, the air in the through-holes and the solvent gas contained in the electroconductive material are discharged to the outside of the through-holes through the air vent passages. Thus, the through-holes can be reliably filled with the electroconductive material without being adversely affected by the air and the solvent gas so that the electrodes of the first substrate can be electrically connected to the wiring patterns of the second substrate reliably. As a result, the excellent laminated substrate, in which the electrodes of the first substrate are electrically connected to the wiring patterns of the second substrate reliably, can be obtained.

In the above laminated substrate, through-holes may be formed on the second substrate so as to communicate with the through-holes of the first substrate and the air vent passages and the wiring patterns formed on the side of the second substrate opposite to the first substrate may be electrically connected to the electroconductive material.

In the above laminated substrate, since the air and the solvent gas can be reliably discharged from the air vent passages, even if the wiring patterns and the lands are formed on, for example, only the side of the second substrate opposite to the first substrate, the conductive material filled in the through-holes passes through the through-holes of the second substrate and is reliably connected to the lands formed on the side of the second substrate opposite to the first substrate, and the wiring patterns formed on the side of the second substrate opposite to the first substrate are electrically connected to the conductive material reliably. Thus, a substrate having the wiring patterns formed on only one side thereof can be used as the second substrate, whereby the laminated substrate can be made at a less expensive cost by lowering a manufacturing cost.

In the above laminated substrate, the electrodes of the first substrate may be disposed on at least the side thereof confronting the second substrate, and at least portions of the electrodes of the first substrate disposed on the side thereof confronting the second substrate may confront the lateral paths.

In the laminated substrate arranged as described above, when the through-holes are filled with the conductive material, the air in the through-holes and the solvent gas are discharged to the outside of the through-holes through the air vent passages as well as a portion of the conductive material enters the lateral paths of the air vent passages. As a result, the electrodes of the first substrate disposed to the side thereof confronting the second substrate can be reliably connected to the conductive material. Accordingly, the excellent laminated substrate can be obtained which is arranged such that the electrodes of the first substrate, which are located in the interior of the laminated substrate by being disposed to the side of the first substrate confronting the second substrate and would not be connected to the conductive material in the conventional laminated substrate, are electrically connected to the conductive material reliably.

In the above laminated substrate, it is preferable that the lateral paths are disposed to a resist layer covering a surface of the first substrate.

In the laminated substrate arranged as described above, the electrodes of the first substrate formed on the side thereof confronting the second substrate can be easily connected to the conductive material.

In the present invention, cutouts, grooves or the like may be formed on at least one of the substrates at the confronting surface thereof so as to form the lateral paths of the air vent passages. Further, the lateral paths of the air vent passages may be formed by cutting the dummy electrodes formed on a substrate on the opposing side thereof.

The laminated substrate of the present invention can be used for various types of electronic products. However, the following description exemplifies a data input device in which the laminated substrate is used.

That is, a data input device of the present invention is characterized by including any of the above laminated substrates wherein the first substrate has x-electrodes and y-electrodes, which are insulated from each other, formed thereon and the change of capacitance between the x-electrodes and the y-electrodes can be detected.

In the data input device arranged as described above, the substrates constituting the laminated substrate can be electrically connected to each other reliably.

In the above data input device, it is preferable that a ground pattern is formed along the edges of the first substrate, the ground pattern exposed from the edges of the first substrate is arranged as a frame ground for discharging capacitance, and a face sheet is laminated on the first substrate through an insulating member.

In the data input device arranged as described above, the ground pattern is formed along the edges of the first substrate and the edges are used as the frame ground. Therefore, even if a one-side substrate having the wiring patterns formed on only one side thereof is used as the second substrate, the frame ground can be formed near to the face sheet.

Further, since the data input device includes any of the above laminated substrates and the air vent passages having the longitudinal paths and the lateral paths are formed through the laminated substrate, it is difficult for the conductive material to pass through the longitudinal paths and the lateral paths of the air vent passages and to extend off the laminated substrate to the outside. Further, even if the conductive material extends of the laminated substrate, the conductive material is not exposed to the outside of the data input device because the extended portion is covered with the face sheet. As a result, the static electricity, which is generated when a finger is in touch with the face sheet, does not adversely affect the internal circuit of the data input device through the conductive material, whereby the data input device excellent in resistance to static electricity can be obtained.

Furthermore, since the frame ground can be formed at a position near to the face sheet and any member for receiving static electricity is not exposed in the vicinity of the frame ground. Thus, static electricity can be reliably discharged to the frame ground. Accordingly, the exposed area of the frame ground can be reduced and the size of the face sheet can be increased. As a result, the frame ground can be arranged at only the ends of the ground pattern and the size of the face sheet can be made as large as the first substrate, whereby the data input device having good appearance can be obtained in which dusts and the like are difficult to deposit on the frame ground and the resistance to static electricity of the frame ground is maintained.

### BRIEF DESCRIPTION OF THE DRAWINGS

FIG. 1 is a view showing an example of a data input device of the present invention.

FIG. 2 is a perspective view showing the main portion of the laminated structure of the data input device shown in FIG. 1.

FIG. 3 is a plan view showing the portion Z in FIG. 1.

FIG. 4 is a sectional view taken along the line IV-IV of FIG. 1.

FIG. 5 is a view showing an example of a conventional data input device.

FIG. 6 is a sectional view of a data input device as a comparative example to the data input device of the present invention.

### DESCRIPTION OF THE PREFERRED EMBODIMENTS

A data input device of the present invention will be described below in detail with reference to the accompanying drawings.

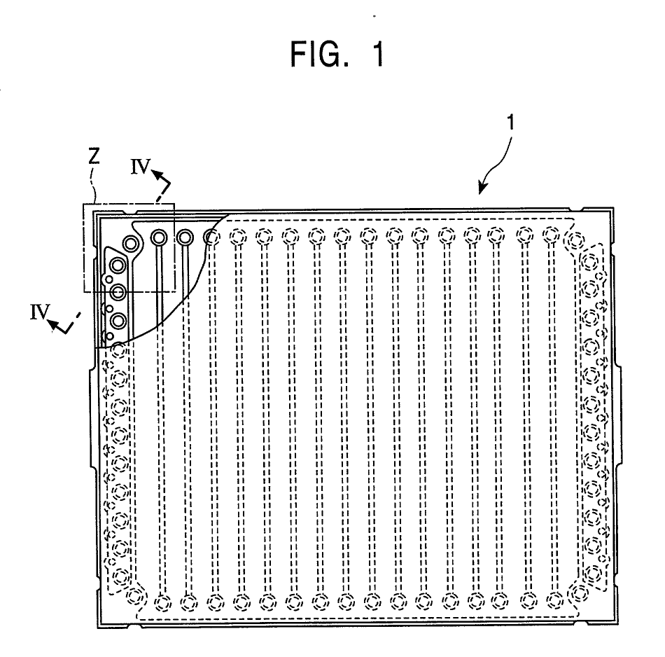

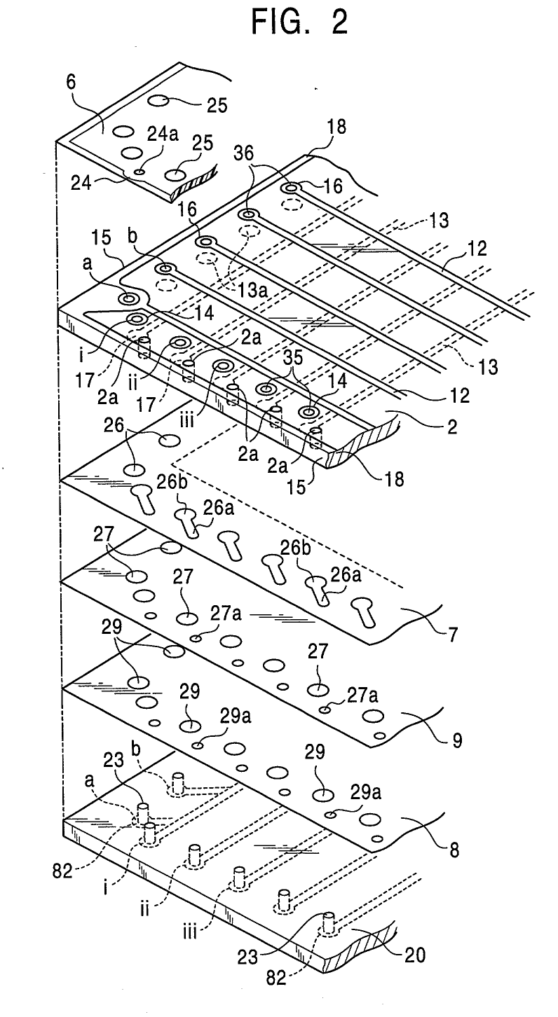

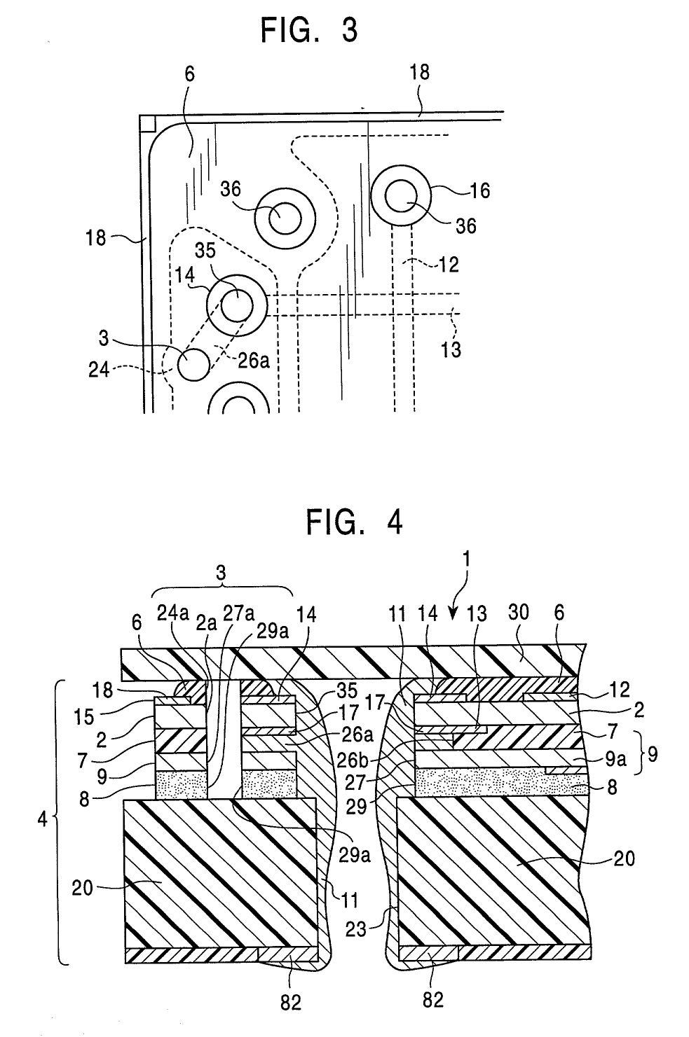

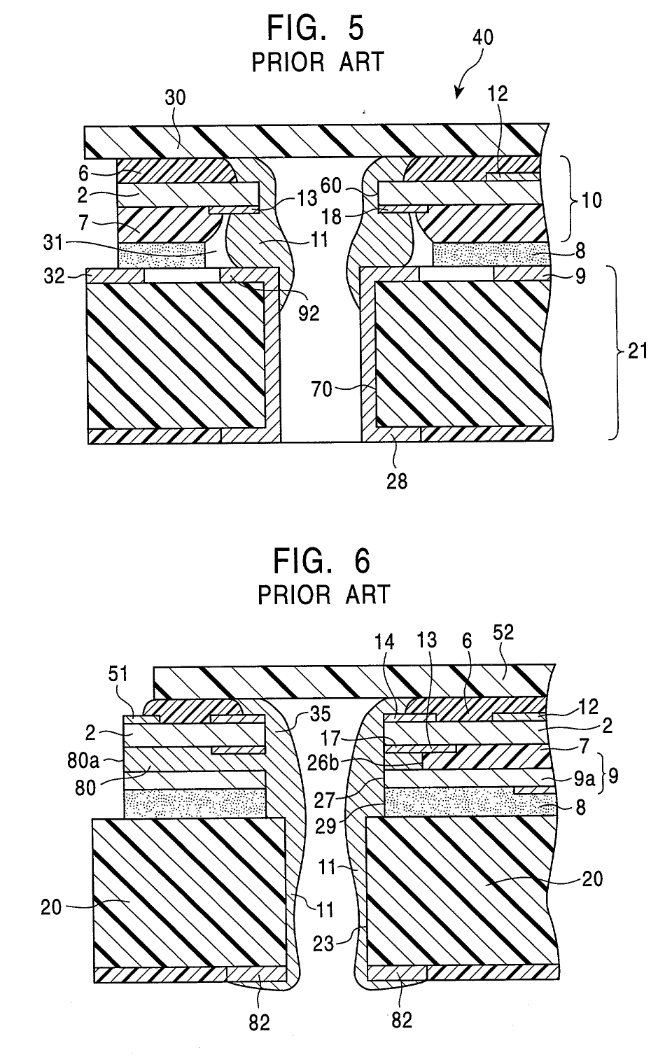

FIG. 1 is a view showing an example of a data input device of the present invention, FIG. 2 is a perspective view showing the main portion of the laminated structure of the data input device shown in FIG. 1, FIG. 3 is a plan view showing the portion Z in FIG. 1, and FIG. 4 is a sectional view taken along the line IV-IV of FIG. 1.

The data input device 1 of this example is a pad type input device used in a computer and the like. As shown in FIGS. 2 and 4, the data input device 1 employs a laminated substrate 4 which comprises a sensor substrate 2 as a first substrate and a printed circuit board (hereafter, abbreviated as PCB) 20. The sensor substrate 2 is bonded to the PCB 20 through a bonding layer 8 serving as an insulating layer. Further, the sensor substrate 2 has electrode patterns formed on both the sides thereof and through-holes formed therethrough, and the PCB 20 has wiring patterns formed on one side thereof.

As shown in FIG. 4, the laminated substrate 4 has air vent passages formed therein. The air vent passages include longitudinal paths 3 and lateral paths 26a. The longitudinal paths 3 pass through the sensor substrate 2 and communicate with the outside from the front surface of the sensor substrate 2, and lateral paths 26a are located between the sensor substrate 2 and the PCB 20 and communicate the longitudinal paths 3 with through-holes 35.

The sensor substrate 2 is composed of a resin sheet of polyethylene terephthalate (PET) or the like. As shown in FIGS. 2 and 4, the sensor substrate 2 has a plurality of x-electrodes 12 formed on the front surface thereof in parallel with each other and a plurality of y-electrodes 13 formed on the back surface thereof in parallel with each other. As shown in FIG. 2, the x-electrodes 12 and the y-electrodes 13 are disposed in a matrix fashion so as to intersect each other and input points are formed at the intersecting portions thereof.

In the data input device 1, capacitance between an x-electrode 12 and a y-electrodes 13 is changed at an input point, whereby coordinate information is input.

As shown in FIG. 2, the ends 17 of the y-electrodes 13 and dummy electrodes 14 confronting the ends 17 are formed along the edges of the sensor substrate 2 which are in parallel with the x-electrodes 12. In contrast, the ends 16 of the x-electrodes 12 and dummy electrodes 13a confronting the ends 16 are formed along the edges of the sensor substrate 2 which are in parallel with the y-electrodes 13.

Then, the through-holes 35 passing through the sensor substrate 2 are formed in the regions where the ends 17 of the y-electrodes 13 confront the dummy electrodes 14, and through-holes 36 passing through the sensor substrate 2 are formed in the regions where the ends 16 of the x-electrodes 12 confront the dummy electrodes 13a in the same manner.

As shown in FIG. 2, air holes 2a, which constitute the longitudinal paths 3 of the air vent passages, are formed externally of the through-holes 35 along the edges of the sensor substrate 2 which are in parallel with the x-electrodes 12.

Further, as shown in FIGS. 2 and 3, a ground pattern 18 is formed on the front surface of the sensor substrate 2 along the edges thereof integrally therewith. As shown in FIGS. 2 and 4, the ends of the ground pattern 18 are exposed externally of the laminated substrate and arranged as a frame ground 15. The frame ground 15 is used to discharge static electricity to the ground.

It is preferable to form the line width of the y-electrodes 13 larger than that of the x-electrodes 12 to enhance resolution. In addition, it is preferable to set the thickness of the sensor substrate (resin sheet) 2 to about 250-800 μm.

As shown in FIGS. 2 and 4, resist films 6 and 7 composed of, for example, an epoxy resin or the like are laminated on both the sides of the sensor substrate 2.

As shown in FIG. 2, air holes 24a and protruding potions 24 are formed along the edges of the resist film 6 which are in parallel with the x-electrodes 12, the resist film 6 being laminated on the front surface (upper side in the figure) of the sensor substrate 2 and serving as the insulating layer on the front surface side of the sensor substrate 2. The air holes 24a constitute portions of the longitudinal paths 3 of the air vent passages, and the protruding potions 24 protrude externally so as to surround the longitudinal paths 3. Further, cutout holes 25 are formed through the resist film 6 at positions at which the ends 16 of the x-electrodes 12 are exposed and which confront the through-holes 36 and at positions at which the dummy electrodes 14 confronting the ends 17 of the y-electrodes 13 are exposed and which confront the through-holes 35.

In contrast, as shown in FIG. 2, the resist film 7, which is disposed on the back surface (lower side in the figure) of the sensor substrate 2 and serves as an insulating layer, includes cutout holes 26, circular holes 26b, and the lateral paths 26a of the air vent passages which are formed through. The cutout holes 26 are formed at positions at which the dummy electrodes 13a of the sensor substrate 2 are exposed and which confront the through-holes 36; the circular holes 26b are formed at positions at which the ends 17 of the y-electrodes 13 are exposed and which confront the through-holes 35; and the lateral paths 26a of the air vent passages are formed continuously from the circular holes 26b to the positions under the air holes 2a formed through the sensor substrate 2.

The resist films 6 and 7 are formed on both the front and back surfaces of the sensor substrate 2 by a print method or the like so as to have the shapes shown in FIG. 2.

As shown in FIGS. 2 and 4, a ground layer 9 is formed on the lower surface of the resist film 7. The ground layer 9 is formed by bonding or printing a Cu foil or an Ag paste to an insulating sheet 9a composed of PET or the like.

As shown in FIG. 2, the ground layer 9 includes air holes 27a constituting portions of the longitudinal paths 3, circular holes 26b formed through the resist film 7 and cutout holes 27 formed at positions confronting the cutout holes 26. The cutout holes 27 are formed so as to communicate with the circular holes 26b or the cutout holes 26.

Further, as shown in FIGS. 2 and 4, the bonding layer 8 is formed on the lower surface of the ground layer 9.

As shown in FIG. 2, the bonding layer 8 has cutout holes 29 formed therethrough at the positions corresponding to the positions of the cutout holes 27, which are formed through the ground layer 9, and air holes 29a, which constitute portions of the longitudinal paths 3, at the positions corresponding to the positions of the air holes 27a. The cutout holes 29 are formed so as to communicate with the circular holes 26b or the cutout holes 26 through the cutout holes 27.

It is preferable that the bonding layer 8 is composed of a hot-melt adhesive or the like.

Further, the bonding layer 8 is formed on the front surface of the PCB 20 or the surface (lower side in the figure) of the ground layer 9 located on the sensor substrate 2 side by a print method or the like so as to have the shape shown in FIG. 2.

As shown in FIGS. 2 and 4, the above PCB 20 serving as the second substrate is a one-side substrate having the wiring patterns formed on only the back surface (lower side in the figure) thereof. As shown in FIG. 2, lands 82 are formed at portions, which confront the dummy electrodes 13a and the ends 17 of the y-electrodes 13 on the sensor substrate 2, on the back surface of the PCB 20. Then, through-holes 23 are formed at the positions of the lands 82. That is, as shown in FIG. 2, the patterns i, ii, iii . . . of the sensor substrate 2 confront the lands i, ii, iii . . . on the PCB 20 side through the through-holes 35 and 23, respectively. Further, the patterns a, b . . . of the sensor substrate 2 confront the lands a, b . . . on the PCB 20 side through the through-holes 36 and 23, respectively.

Further, wiring patterns extending from the lands 82 are formed on the back surface of the PCB 20 and electronic parts such as an IC and the like are mounted so as to be connected to the wiring patterns.

As shown in FIGS. 2 and 4, the laminated substrate, which is arranged such that the sensor substrate 2 is laminated on the PCB 20 and bonded thereto through the bonding layer 8, is filled with the electroconductive material 11 from the through-holes 35 and 36 of the sensor substrate 2.

An electroconductive resin composed of a thermosetting resin such as an epoxy resin, phenol resin or polyester resin mixed with an electroconductive filler such as Ag or the like can be used as the electroconductive material 11. The electroconductive material 11 is filled by a screen print method or the like with a squeegee at the positions on the surface of the sensor substrate 2 where the through-holes 35 and 36 shown in FIG. 2 are formed.

Then, the x-electrodes 12 and the ends 17 of the y-electrodes 13 on the sensor substrate 2 are electrically connected to the lands 82 on the back surface of the PCB 20, whereby the laminated substrate 4 is fabricated.

As shown in FIGS. 3 and 4, in the laminated substrate 4 arranged as described above, the air vent passages, which are composed of the longitudinal paths 3 and the lateral paths 26a, communicate the spaces in the through-holes 35 and 23 with the spaces externally of the laminated substrate 4. In the above arrangement, the longitudinal paths 3 are composed of the air holes 24a, 2a, 27a and 29a and communicate with the outside from the front surface of the sensor substrate 2 passing therethrough. In contrast, the lateral paths 26a are continuously formed from the circular holes 26b of the resist film 7 to positions under the longitudinal paths 3 and communicates the longitudinal paths 3 with the through-holes 35 and 23.

Therefore, when the electroconductive material 11 is filled from the through-holes 35 to the through-holes 23, the air in the through-holes 35 and 23, the air in the circular holes 26b of the resist film 7, the cutout holes 27 of the ground layer 9 and the cutout holes 29 of the bonding layer 8 which are located at the positions corresponding to the positions of the through-holes 35 and 23, the solvent gas contained in the electroconductive material 11, and the like are discharged to the outside of the laminated substrate 4 through the lateral paths 26a and the longitudinal paths 3 of the air vent passages. Then, as shown in FIG. 4, a portion of the electroconductive material 11 enters the lateral paths 26a of the air vent passages.

As a result, the y-electrodes 13, which are disposed on the lower side of the sensor substrate 2 and located in the interior of the laminated substrate 4 where they would not be connected to the electroconductive material 11 in the conventional laminated substrate, can be reliably connected to the electroconductive material 11 in the through-holes 35 and the lateral paths 26a, whereby the y-electrodes 13 can be electrically connected to the lands 82 reliably through the conductive material 11 in the laminated substrate.

Since the laminated substrate 4 is not adversely affected by the air and the solvent gas, a one-side substrate having wiring patterns formed on only the back surface thereof (lower side in the figure) can be used as the PCB 20 as the second substrate. Thus, the laminated substrate 4 can be made at a less expensive cost by lowering a manufacturing cost.

Since the laminated substrate 4 is not adversely affected by the air and the solvent gas, the laminated substrate 4, in which the sensor substrate 2 is electrically connected to the PCB 20 reliably, can be easily obtained by coating the electroconductive material 11 with a squeegee using an ordinary screen print method and filling it.

Further, since the lateral paths 26a are disposed to the resist film 7 and the y-electrodes 13, which are disposed on the back surface of the sensor substrate 2, confront the lateral paths 26a, when the electroconductive material 11 is filled, the y-electrodes 13 can be more reliably connected to the electroconductive material 11 by the electroconductive material 11 entering the lateral paths 26a.

In the laminated substrate of the present invention, while the air vent passages are formed along the edges of the sensor substrate 2 which are in parallel with the x-electrodes 12 as in the above example, they may be also formed along the edges which are in parallel with the y-electrodes 13. In the laminated substrate arranged as described above, the x-electrodes 12 of the sensor substrate 2 can be electrically connected to the lands 82 reliably through the conductive material 11.

In the laminated substrate of the present invention, while the air vent passages can be disposed externally of the through-holes 35 as in the above example, they may be located at positions in the vicinity of the through-holes 35. For example, they may be disposed internally of the through-holes 35 or between the through-holes 35. That is, their positions are not particularly limited.

Further, in the laminated substrate of the present invention, the lateral paths 26a can be disposed to the resist film 7 as in the above example. However, they may be disposed over the two layers of the resist film 7 and the ground layer 9 or may be disposed to both the resist film 7 and the bonding layer 8.

Since the y-electrodes 13, which are formed on the back surface of the sensor substrate 2, confront the lateral paths 26a also in the laminated substrate arranged as described above, when the electroconductive material 11 is filled, the y-electrodes can be more reliably connected to the electroconductive material 11 by the electroconductive material 11 entering the lateral paths 26a.

It is sufficient that at least one lateral path 26a is disposed between the sensor substrate 2 as the first substrate and the PCB 20 as the second substrate so as to communicate the longitudinal paths 3 with the through-holes 35. For example, cutouts, grooves or the like may be formed on at least one of the sensor substrate 2 and the PCB 20 at the confronting surface thereof so that they act as the lateral paths of the air vent passages. Further, when, for example, the air vent passages are formed along the edges which are in parallel with the y-electrodes 13, the lateral paths of the air vent passages may be formed by cutting the dummy electrodes 13a formed on the sensor substrate 2 on the opposing side thereof.

Further, in the laminated substrate of the present invention, the longitudinal paths 3 can be composed of the air holes 24a, 2a, 27a and 29a, it is sufficient that the longitudinal paths 3 pass through the sensor substrate 2 and communicate with the outside from the front surface of the sensor substrate 2. That is, the longitudinal paths 3 may be composed of the air holes 24a and 2a or the holes 24a, 2a and 27a.

As shown in FIG. 4, the data input device 1 of the present invention is arranged such that the face sheet 30, which a finger is in touch with when data is input, is laminated on the upper surface of the resist film 6 of the laminated substrate 4.

In the data input device 1 arranged as described above, when the operator slides the face sheet 30 by lightly scraping it with his or her finger, a portion of the electric line of force which is directed from the x-electrodes 12 to the y-electrodes 13 is absorbed by the operator's finger in the x-electrodes 12 and the y-electrodes 13 formed on the sensor substrate 2. With this operation, there arises a phenomenon that the electric line of force absorbed by the y-electrodes 13 is reduced and capacitance is changed. Then, the coordinate against which the finger is pressed is detected based on the current value output from the sensor substrate 2 which is changed in accordance with the change of the capacitance.

The data input device 1 arranged as described above includes the above laminated substrate 4, and a portion of the ground pattern 18 formed on the upper surface of the sensor substrate 2 is exposed to the upper surface of the laminated substrate 4 as shown in FIGS. 3 and 4. The ends of the ground pattern 18 are exposed to the outside of the laminated substrate 4 and arranged as the frame ground 15. Since the position of the frame ground 15 is located near to the face sheet 30 disposed on the laminated substrate 4, the static electricity charged to the face sheet 30 is liable to be discharged to the frame ground 15.

Incidentally, the inventors filed a data input device shown in FIG. 6 whose structure is similar to that of the data input device of the present invention.

In the data input device, air vent passages 80 are arranged such that the lateral paths 26a of the air vent passages of the data input device 1 of the present invention shown in FIG. 4 are extended up to the ends of the laminated substrate.

The above data input device can also discharge the air in the through-holes 35 and 23, the air in the circular holes 26b and the cutout holes 27 and 29, the solvent gas and the like to the outside of the laminated substrate, whereby the laminated substrate can be arranged such that the y-electrodes 13 are electrically connected to the lands 82 reliably through the above electroconductive material 11.

In the data input device shown in FIG. 6, however, the openings of the air vent passages 80 are exposed to the ends of the laminated substrate. Thus, the electroconductive material 11 is liable to pass through the air vent passages 80 and extend off the ends of the laminated substrate. The extended electroconductive material 11 is exposed to the outside of the data input device. Accordingly, there is a possibility that the static electricity, which is generated when a finger is in touch a face sheet 52, adversely affects the internal circuit of the data input device through the exposed portion 80a of the electroconductive material 11.

Therefore, it is contemplated that a problem of the data input device shown in FIG. 6 resides in that the exposed area of a frame ground 51 must be increased by making the face sheet 52 smaller than sensor substrate 2 to permit the static electricity to be discharged to the frame ground 51 so that it is difficult for the static electricity to be discharged to the exposed portion 80a even if the exposed portion 80a is formed.

In the data input device 1 of the present invention, since the air vent passages having the lateral paths 26a and the longitudinal paths 3 are formed through the laminated substrate 4, it is difficult for the electroconductive material 11 to extend off the laminated substrate 4 to the outside from the longitudinal paths 3 of the air vent passages. Further, even if the electroconductive material 11 extends off the laminated substrate 4, the extended portion is covered with the face sheet 30, whereby the electroconductive material 11 does not extend off the data input device 1 to the outside. As a result, the static electricity, which is generated when a finger is in touch with the face sheet 30, does not adversely affect the data input device 1 through the electroconductive material 11 so that the data input device 1 excellent in resistance to static electricity can be provided.

Further, since the frame ground 15 can be formed at a position near to the face sheet 30, any member for receiving static electricity such as the exposed portion 80a of the data input device shown in FIG. 6 is not exposed in the vicinity of the frame ground 15. Thus, static electricity can be reliably discharged to the frame ground 15. Further, since any portion such as the exposed portion 80a of the data input device shown in FIG. 6, which is adversely affected by static electricity, is not exposed in the vicinity of the frame ground 15, there is little possibility that the data input device is adversely affected by the static electricity.

Accordingly, the exposed area of the frame ground 15 can be reduced and the size of the face sheet 30 can be increased. As a result, the frame ground 15 can be arranged at only the ends of the ground pattern 18 and the size of the face sheet 30 can be made as large as the sensor substrate 2, whereby there can be provided the data input device 1 having good appearance in which dusts and the like are difficult to deposit on the frame ground 15 and the resistance to static electricity of the frame ground 15 is maintained.

As described above, since the air vent passages having the longitudinal paths and the lateral paths are formed through the laminated substrate of the present invention, when the through-holes are filled with the electroconductive material such as the electroconductive resin or the like, the air in the through-holes and the solvent gas contained in the electroconductive material can be discharged to the outside of the through-holes through the air vent passages. Thus, the through-holes can be reliably filled with the electroconductive material without being adversely affected by the air and the solvent gas. As a result, the excellent laminated substrate, in which the electrodes of the first substrate are electrically connected to the wiring patterns of the second substrate reliably, can be provided.

The second substrate has the through-holes, which communicate with the through-holes of the first substrate and the air vent passages, formed threat and the wiring patterns, which are formed on the side of the second substrate opposite to the first substrate, are electrically connected to the electroconductive material. Thus, the substrate having the wiring patterns formed on only one side thereof can be used as the second substrate, whereby the laminated substrate can be made at a less expensive cost by lowering a manufacturing cost.

Since the data input device of the present invention includes the laminated substrate of the present invention, the excellent data input device, in which the electrodes of the first substrate are electrically connected to the wiring patterns of the second substrate reliably, can be provided.

Since the ground pattern is formed on the first substrate, the ground pattern extending off the ends of the first substrate is arranged as the frame ground and the face sheet is laminated on the first substrate, the frame ground can be formed at the position near to the face sheet even if the second substrate is the one-side substrate having the wiring patterns only on the one side thereof.

Since the conductive material is not exposed to the outside of the data input device, the data input device is not adversely affected by static electricity through the conductive material, whereby the excellent laminated substrate can be provided.

Further, the exposed area of the frame ground can be reduced and the size of the face sheet can be increased because static electricity can be reliably received by the face sheet. As a result, since the face sheet can be made as large as the sensor substrate, there can be provided the data input device having good appearance in which dusts and the like are difficult to deposit on the frame ground and the resistance to static electricity of the frame ground is maintained.

What is claimed is:

1. A laminated substrate comprising:
a first substrate having electrodes and through-holes formed thereon;
a second substrate having wiring patterns formed thereon and laminated under said first substrate through an insulating layer;
an electroconductive material filled in the through-holes so that the electrodes of said first substrate are electrically connected to the wiring patterns of the second substrate therethrough; and
air vent passages having longitudinal paths passing through said first substrate and communicating with the outside from the front surface of said first substrate and lateral paths located between said first substrate and said second substrate for communicating the longitudinal paths with the through-holes.

2. A laminated substrate according to claim 1, wherein:
through-holes are formed on the second substrate so as to communicate with the through-holes of said first substrate and the air vent passages; and
the wiring patterns formed on the side of said second substrate opposite to the first substrate are electrically connected to the electroconductive material.

3. A laminated substrate according to claim 1, wherein:
the electrodes of said first substrate are disposed on at least the side thereof confronting said second substrate; and
at least portions of the electrodes of said first substrate disposed on the side thereof confronting said second substrate confront the lateral paths.

4. A laminated substrate according to claim 1, wherein the lateral paths are disposed to a resist layer covering a surface of said first substrate.

5. A data input device comprising a laminated substrate according to any of claims 1 to 4 wherein said first substrate has x-electrodes and y-electrodes, which are insulated from each other, formed thereon and the change of capacitance between the x-electrodes and the y-electrodes can be detected.

6. A data input device according to claim 5, wherein:
a ground pattern is formed along the edges of said first substrate;
the ground pattern exposed from the edges of said first substrate is arranged as a frame ground for discharging capacitance; and
a face sheet is laminated on said first substrate through an insulating member.
